(19) United States
(12) Patent Application Publication
(10) Pub. No.: US 2007/0234403 A1
(43) Pub. Date: Oct. 4, 2007

(54) Program Code Version Enforcement

(75) Inventors: Brent Pipal, Eagle, ID (US); Daryl Robert Hyland, Boise, ID (US)

Correspondence Address: LEE & HAYES PLLC, 421 W RIVERSIDE AVENUE SUITE 500, SPOKANE, WA, 99201, US

(73) Assignee: MICROSOFT CORPORATION, Redmond, WA (US)

(21) Appl. No.: 11/746,706

(22) Filed: May 10, 2007

Related U.S. Application Data
(62) Division of application No. 10/698,598, filed on Oct. 31, 2003.

(51) Int. Cl. G06F 7/04

(52) U.S. Cl. 726/2

(57) ABSTRACT

Implementations described and claimed herein enforce versions of program code on a client based on an operating policy during execution of the software. The version of program code on the client is checked for compliance with the operating policy when the client attempts to execute the program code or access a resource. If the program code on the client does not comply with the operating policy, the client is unable to execute the noncompliant program code or access the resource.

### RELATED APPLICATIONS

This application is a divisional of and claims priority to U.S. patent application Ser. No. 10/698,598 entitled “Program Code Version Enforcement” filed Oct. 31, 2003 to Pipal et al., the disclosure of which is incorporated by reference herein.

### TECHNICAL FIELD

The described subject matter relates to electronic computing, and more particularly to systems and methods of program code version enforcement in electronic computing systems.

### BACKGROUND

Software developers allocate significant time and money resources testing their software before releasing it to the consumer. This testing may include the use of beta versions of the software for actual user testing, and more recently, automated testing to simulate the operations of many users over an extended time. But even after extensive testing, software may still be released with defects in the program code, commonly referred to as bugs, or as security holes where the defect introduces security vulnerabilities. When a bug or security hole is discovered after the software has been released, the developer produces and distributes a hotfix or patch as a partial replacement or addition to the defective program code. In some scenarios, the developer may release a set of patches together as a service pack.

The patches or service packs are often made available at the developer's website for the user of the software product to download. The developer may notify users directly or the user may learn about the availability of a patch or service pack, for example, in a news article or a service bulletin on the Internet. Oftentimes, however, the user does not learn of the availability of a patch or service pack, making the user's computer vulnerable to attackers if the defect introduces security vulnerabilities.

It is desirable to update every computer with the most recent patch or service pack as soon as possible after it becomes available in order to reduce the occurrence of security breaches. In the past, this task has been accomplished by auditing all of the software on each of the computers in a user's network and updating the software as necessary with available patches or service packs. This task can be accomplished manually, wherein the network administrator checks the version of all of the software installed on each computer in the network. Alternatively, this task can be accomplished automatically by a server individually polling the computers in a network and checking the version of all the installed software.

In either case, auditing is a time-consuming, resource-intensive task. In addition, checking the version of all of the software on one computer before moving on to the next computer in the network delays application of the patch or service pack on at least some of the computers. Depending on the number of computers in the network, and the number of software programs installed on each computer, this delay can be significant (e.g., several hours to several days or more) and gives attackers an opportunity to exploit computers that have not yet been updated. Furthermore, another computer may be introduced onto the network after the auditing process is complete. If this computer hasn't already been updated with the most recent patch or service pack, it may serve as a gateway for an attacker to exploit the other computers on the network.

### SUMMARY

Implementations described and claimed herein enforce versions of program code based on an operating policy during execution of the software. The version of program code is checked for compliance with the operating policy when the client attempts to execute the program code or access a resource. If the program code does not comply with the operating policy, the client is unable to execute the noncompliant program code or access the resource. In this manner, the client software does not have to be periodically audited to determine whether the client software needs to be updated.

In some implementations, articles of manufacture are provided as computer program products. One implementation of a computer program product provides a computer program storage medium readable by a computer system and encoding a computer program for version enforcement. Another implementation of a computer program product may be provided in a computer data signal embodied in a carrier wave by a computing system and encoding the computer program for version enforcement.

The computer program product encodes a computer program for executing on a computer system a computer process that determines a version of program code satisfying an operating policy, and denies a client access to a resource if a version of the program code on the client attempting to access the resource is different from the version of program code satisfying the operating policy.

In another implementation, the computer program product encodes a computer program for executing on a computer system a computer process that determines a version of program code satisfying an operating policy, and denies execution of program code on a client if a version of the program code on the client is different from the version of program code satisfying the operating policy.

In another implementation, a method is provided. A version of program code satisfying an operating policy is determined. A client is denied access to a resource if a version of the program code on the client attempting to access the resource is different from the version of program code satisfying the operating policy.

In yet another implementation, another method is provided. A version of program code satisfying an operating policy is determined. Execution of program code on a client is denied if a version of the program code on the client is different from the version of program code satisfying the operating policy.

In yet another implementation, a system is provided including an operating policy and a compliance module. The compliance module accesses the operating policy and denies a client access to a resource if a version of program code on the client attempting to access the resource is different from a version of program code satisfying the operating policy.

In yet another implementation, another system is provided. The system includes an operating policy and a compliance module. The compliance module accesses the operating policy and denies execution of program code on a client if a version of the program code on the client is different from the version of program code satisfying the operating policy.

### BRIEF DESCRIPTION OF THE DRAWINGS

FIG. 1 is a schematic illustration of an exemplary implementation of a network;

FIG. 2 is a schematic illustration of an exemplary computing device that can be utilized to implement a host or a client on a network;

FIG. 3 is a schematic illustration showing an exemplary implementation of a client connected to a host on a network;

FIG. 4 is a schematic illustration of an exemplary implementation of an operating policy;

FIGS. 5(a) and (b) are schematic illustrations of a client showing an exemplary implementation of program code version enforcement;

FIGS. 6(a) and (b) are schematic illustrations of a client and a host showing another exemplary implementation of program code version enforcement; and

FIG. 7 is a flowchart illustrating exemplary operations implemented to enforce at least one program code version at a client.

### DETAILED DESCRIPTION

Program code version enforcement may be implemented by a client and/or host in a network environment. The client connects to the network, such as, e.g., via an Ethernet connection, and may be authenticated during a logon session, although authentication is not required.

In operation, the client may attempt to execute program code or access a resource (e.g., via the host on the network). It is determined whether a version of the program code on the client satisfies the version defined by an operating policy. If the program code is compliant with the operating policy, the client executes the program code and/or is granted access to the resource. On the other hand, if the program code is noncompliant, the client is unable to execute the program code and/or is denied access to the resource.

Exemplary Architecture

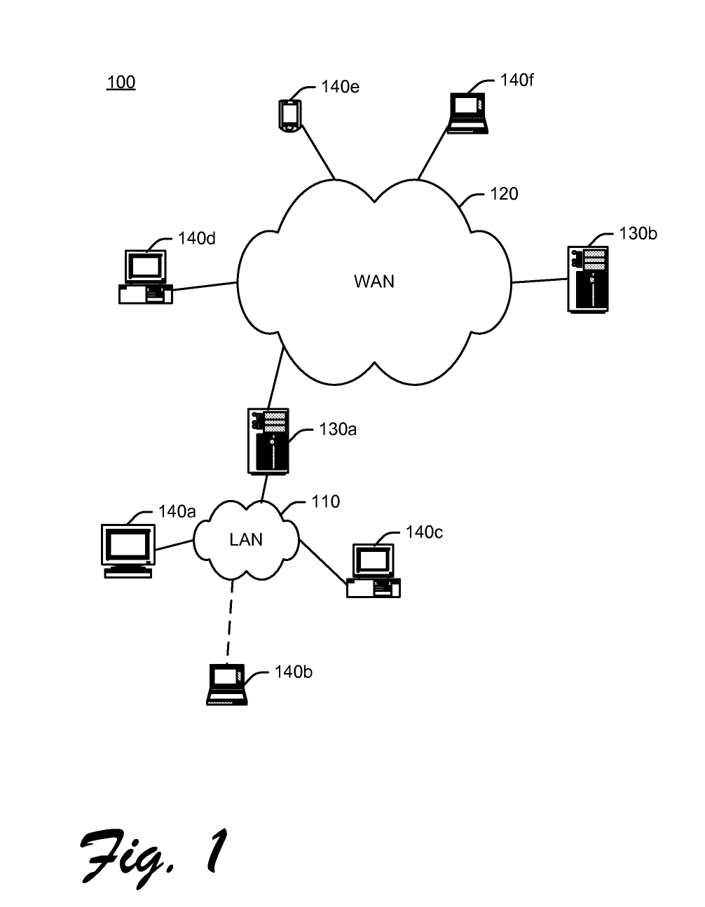

FIG. 1 is a schematic illustration of an exemplary networked computing system 100 in which program code enforcement may be implemented. The networked computer system 100 may include one or more communication networks, such as local area network (LAN) 110 and/or wide area network (WAN) 120. One or more hosts 130a, 130b (hereinafter, generally referred to as 130) may be linked to one or more clients 140a-f (hereinafter, generally referred to as 140) over the communication network(s) 110, 120.

As used herein, the term “host” refers to the hardware and software (the entire computer system) used to perform various network services (i.e., the server application). A host may include a computing system(s), such as a server, that also runs other applications or, it may refer to a computing system dedicated only to server applications. A host connects to a network via a communication connection such as, e.g., an Ethernet connection.

Host 130 may provide services to other computing or data processing systems or devices. For example, a server may access network resources and/or start processes at the server on behalf of the client. A secured server can also protect private resources, determine whether a client is allowed access to private resources, and generate audit messages (e.g., in an event log) when a client attempts to access private resources. Host 130 may also provide other services, such as transaction processing, email services, etc.

As used herein, the term “client” refers to the hardware and software (the entire computer system) used to perform various computing services. A client may include a computing system(s), such as a stand-alone personal desktop or laptop computer (PC), workstation, personal digital assistant (PDA), or appliance, to name only a few. A client connects to a network via a communication connection such as, e.g., an Ethernet connection. The number of clients that can be included in any network is limited primarily by the connectivity implemented in the communication network.

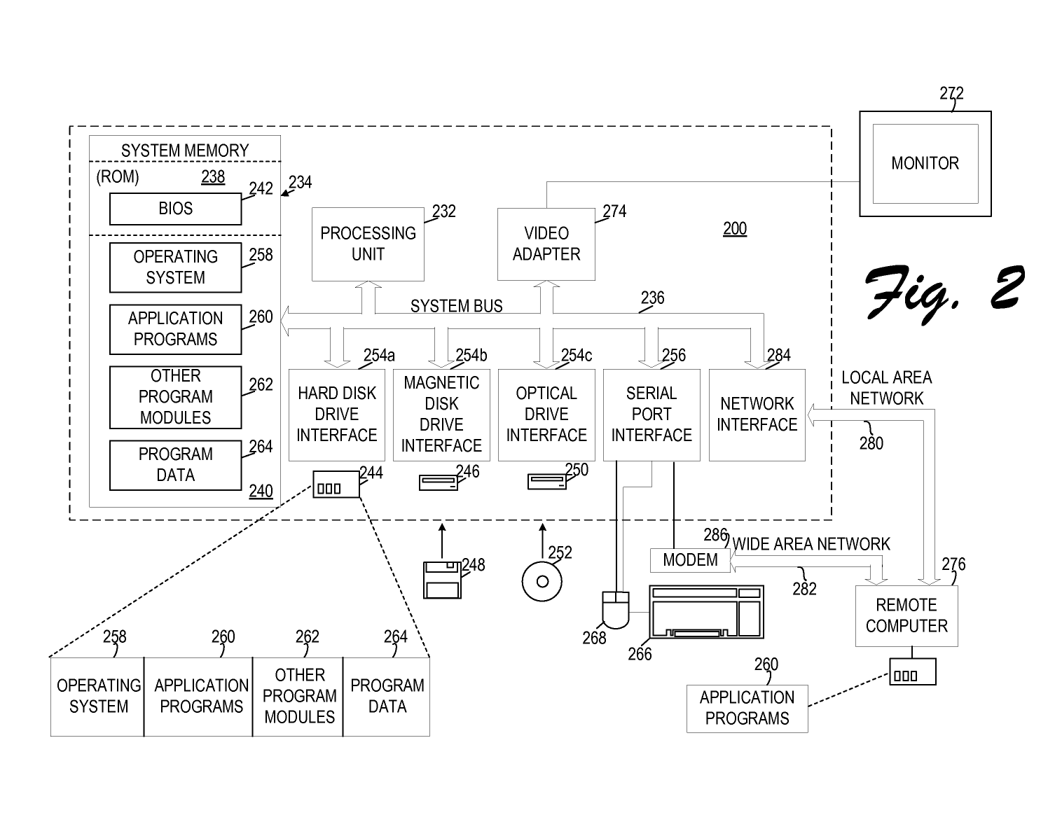

Hosts 130 are typically implemented as server computers. FIG. 2 is a schematic illustration of an exemplary computing device 200 that can be utilized to implement a host. Computing device 200 includes one or more processors or processing units 232, a system memory 234, and a bus 236 that couples various system components including the system memory 234 to processors 232. The bus 236 represents one or more of any of several types of bus structures, including a memory bus or memory controller, a peripheral bus, an accelerated graphics port, and a processor or local bus using any of a variety of bus architectures. The system memory 234 includes read only memory (ROM) 238 and random access memory (RAM) 240. A basic input/output system (BIOS) 242, containing the basic routines that help to transfer information between elements within computing device 200, such as during start-up, is stored in ROM 238.

Computing device 200 further includes a hard disk drive 244 for reading from and writing to a hard disk (not shown), and may include a magnetic disk drive 246 for reading from and writing to a removable magnetic disk 248, and an optical disk drive 250 for reading from or writing to a removable optical disk 252 such as a CD ROM or other optical media. The hard disk drive 244, magnetic disk drive 246, and optical disk drive 250 are connected to the bus 236 by appropriate interfaces 254a, 254b, and 254c. The drives and their associated computer-readable media provide nonvolatile storage of computer-readable instructions, data structures, program modules and other data for computing device 200. Although the exemplary environment described herein employs a hard disk, a removable magnetic disk 248 and a removable optical disk 252, other types of computer-readable media such as magnetic cassettes, flash memory cards, digital video disks, random access memories (RAMs), read only memories (ROMs), and the like, may also be used in the exemplary operating environment.

A number of program modules may be stored on the hard disk 244, magnetic disk 248, optical disk 252, ROM 238, or RAM 240, including an operating system 258, one or more application programs 260, other program modules 262, and program data 264. A user may enter commands and information into computing device 200 through input devices such as a keyboard 266 and a pointing device 268. Other input devices (not shown) may include a microphone, joystick, game pad, satellite dish, scanner, or the like. These and other input devices are connected to the processing unit 232 through an interface 256 that is coupled to the bus 236. A monitor 272 or other type of display device is also connected to the bus 236 via an interface, such as a video adapter 274.

Generally, the data processors of computing device 200 are programmed by means of instructions stored at different times in the various computer-readable storage media of the computer. Programs and operating systems may be distributed, for example, on floppy disks, CD-ROMs, or electronically, and are installed or loaded into the secondary memory of a computer. At execution, the programs are loaded at least partially into the computer's primary electronic memory.

Computing device 200 may operate in a networked environment using logical connections to one or more remote computers, such as a remote computer 276. The remote computer 276 may be a personal computer, a server, a router, a network PC, a peer device or other common network node, and typically includes many or all of the elements described above relative to computing device 200. The logical connections depicted in FIG. 2 include a LAN 280 and a WAN 282.

When used in a LAN networking environment, computing device 200 is connected to the local network 280 through a network interface or adapter 284. When used in a WAN networking environment, computing device 200 typically includes a modem 286 or other means for establishing communications over the wide area network 282, such as the Internet. The modem 286, which may be internal or external, is connected to the bus 236 via a serial port interface 256. In a networked environment, program modules depicted relative to the computing device 200, or portions thereof, may be stored in the remote memory storage device. It will be appreciated that the network connections shown are exemplary and other means of establishing a communications link between the computers may be used.

Hosts may include host adapter hardware and software to enable a connection to the communication network. The connection to communication network may be through an optical coupling or more conventional conductive cabling depending on the bandwidth requirements. A host adapter may be implemented as a plug-in card on computing device 200. Hosts may implement any number of host adapters to provide as many connections to communication network as the hardware and software support.

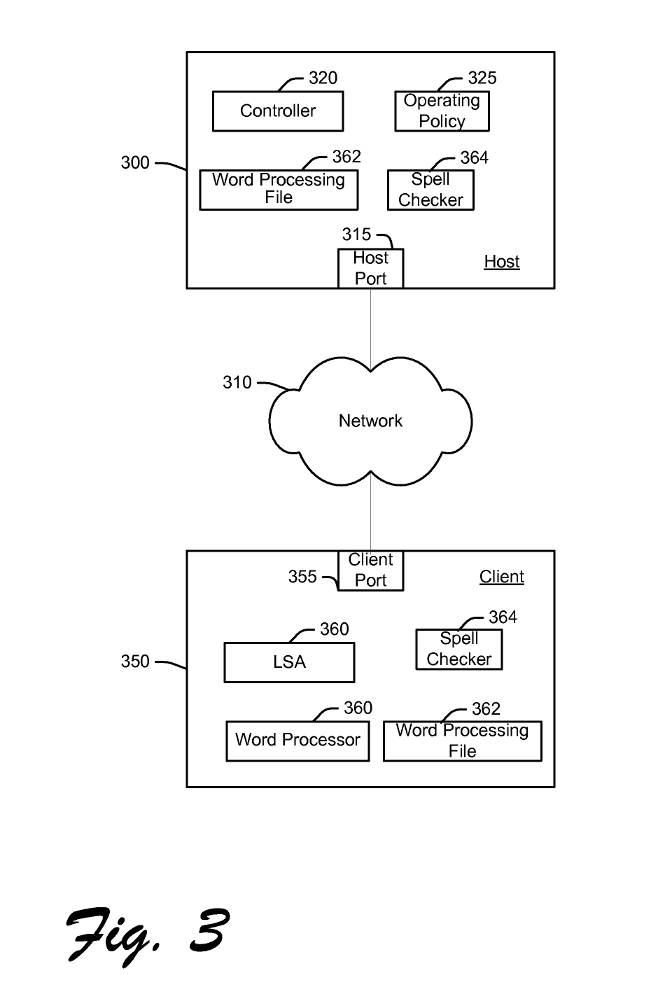

FIG. 3 is a schematic illustration showing an exemplary implementation of a client connected to a host on a network. Referring to FIG. 3, exemplary host 300 may be connected to a network 310 via port 315. A controller 320 is also included to manage devices on the network 310 by administering an operating policy 325.

By way of example, a domain controller may be provided to manage clients in a domain on the network by administering a domain policy. Domains are groups of computers or devices on a network that are managed according to common rules and procedures defined by a domain policy. According to one implementation, all devices in the network which share a common portion of an IP address are said to be in the same domain on the network.

In the exemplary implementation shown in FIG. 3, client 350 is embodied as a personal computer or workstation linked to network 310 via port 355. Exemplary client 350 may include a local security authority (LSA) 360. LSA 360 is a protected subsystem that logs a user onto the local system and maintains information about the local security. LSA 360 may also communicate with host 300 to authenticate the client 350 in a domain on the network 310.

To join a domain in the network 310, client 350 typically has to be authenticated by the host 300 managing the domain. Authentication may occur during a logon session.

According to one exemplary implementation, a logon session begins when a user logs onto client 350. The user provides various identification and security information, or credentials, to the client 350 and the user is then authenticated locally at the client 350 (e.g., by LSA 360). The client 350 may also identify itself to host 300 to join a domain in the network 310.

Before continuing, it should be noted that the implementation described herein is illustrative of an exemplary logon session as it may be implemented in a MICROSOFT WINDOWS®-based networking environment (Microsoft Corporation). However, other implementations for connecting a client in a network or on a domain in the network are also contemplated and should not be limited to any particular networking environment or procedure for connecting clients in a network or on a domain in the network.

Regardless of whether the client is authenticated in a domain or is otherwise on the network, the operating policy may be used to manage access to resources. For purposes of illustration, a user may attempt to execute word processing software 360 at client 350. Alternatively, a user executing word processing software 360 at client 350 may attempt to access a word processing file 362 or a spell checker 364 at the host 300 or client 350. Before the user can execute the word processing software 360, or before the user is granted access to the word processing file 362 or spell checker 364, the version of the word processing software 360 is checked for compliance with the operating policy 325.

It is determined whether the version of the word processing software satisfies the version defined by the operating policy 325 (e.g., version 1.2.3.4.5). If the word processing software is compliant (e.g., version 1.2.3.4.5), the client executes the program code and/or is granted access to the resource. On the other hand, if the word processing software is noncompliant (e.g., version 1.2.3.4.4), the client is unable to execute the program code and/or is denied access to the resource.

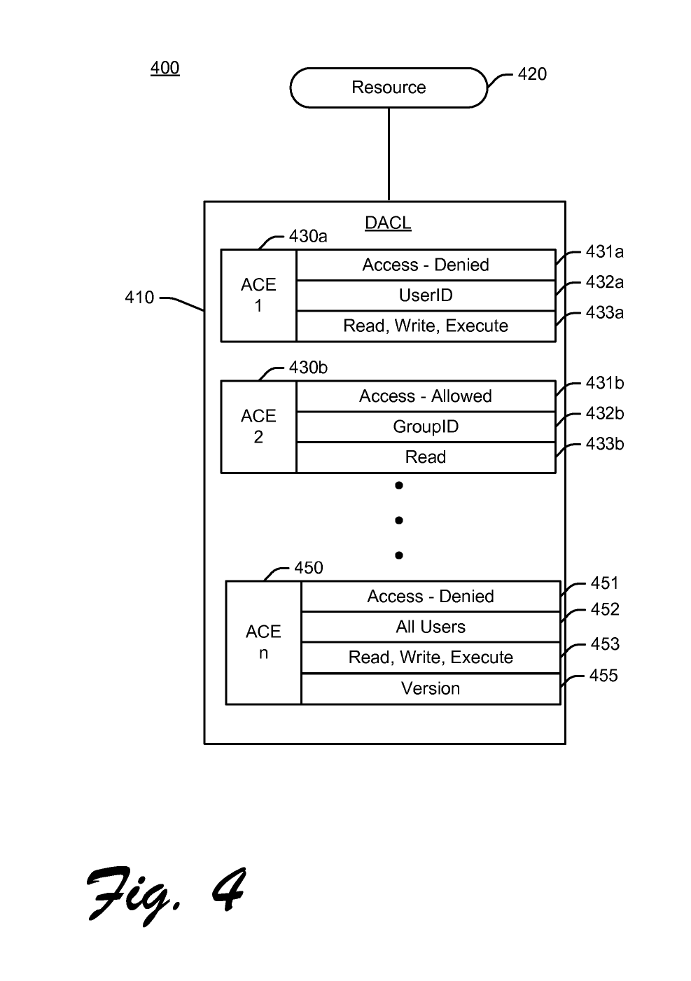

FIG. 4 is a schematic illustration of an exemplary implementation of an operating policy. Referring to FIG. 4, the operating policy is implemented as a domain policy 400 including access rights for one or more resources in the domain. The domain policy 400 contains one or more access control lists (ACL) in general, and in this implementation, one or more discretionary access control lists (DACL) 410 associated with one or more resources 420. Resource 420 may be hardware, software or files (e.g., program code), or a combination thereof that is available at the client, at the host, and/or elsewhere on the network.

An ACL is a list of security protections that apply to a resource. A DACL is an access control list that is controlled by the owner of the resource and specifies access rights for the resource by particular users or groups in the network. Exemplary DACL 410 includes one or more security protections for an resource, as defined in access control entries (ACE) 430a, 430b, and 450.

An ACE is an element or entry in an ACL that defines access rights and identifies the user or group for whom the rights are allowed, denied, or audited. By way of example, ACE 430a includes an Access-Denied entry 431a, a UserID entry 432a, and Access Rights 433a. ACE 430a denies the identified client(s) read, write, and execute rights for resource 420. ACE 430b includes an Access-Allowed entry 431b, a GroupID entry 432b, and Access Rights 433b, which grants read rights to client(s) identified by the GroupID.

It should be noted that an ACL is not limited to any number of security protections. In general, providing more ACEs increases the granularity of protection for an resource.

It should also be noted that when a client attempts to access an resource, the domain controller steps through the ACEs in the resource's ACL until it finds ACEs that allow or deny the requested access and then allows or denies access to the resource. Consequently, in this implementation all access-denied ACEs should precede any access-allowed ACE so that the access-denied ACEs are enforced regardless of any ACE that allows access. However, implementations are not limited to any particular manner of reading an ACL. For example, in other implementations all of the access-denied ACEs may be processed prior to processing an access-allowed ACE.

Exemplary DACL 410 also includes ACE 450, which may be defined in one exemplary implementation for program code version enforcement. Exemplary ACE 450 includes an Access-Denied entry 451, user or group ID entry 452, Access Rights 453, and at least one version entry 455 defining one or more compliant versions of program code.

The compliant version may be formatted in any suitable manner and may depend at least to some extent on various design considerations. For example, the compliant version may be formatted as a version number assigned to the software code by the developer (e.g., version 1.2.3.4.4) and updated when the patch or service pack is applied (e.g., to version 1.2.3.4.5). Alternatively, the version may be formatted as a distribution date and/or the date of any patches or service packs. The version may also be a combination of different parameters (e.g., version number and date). Of course these are provided only as exemplary implementations and should not be limited thereto.

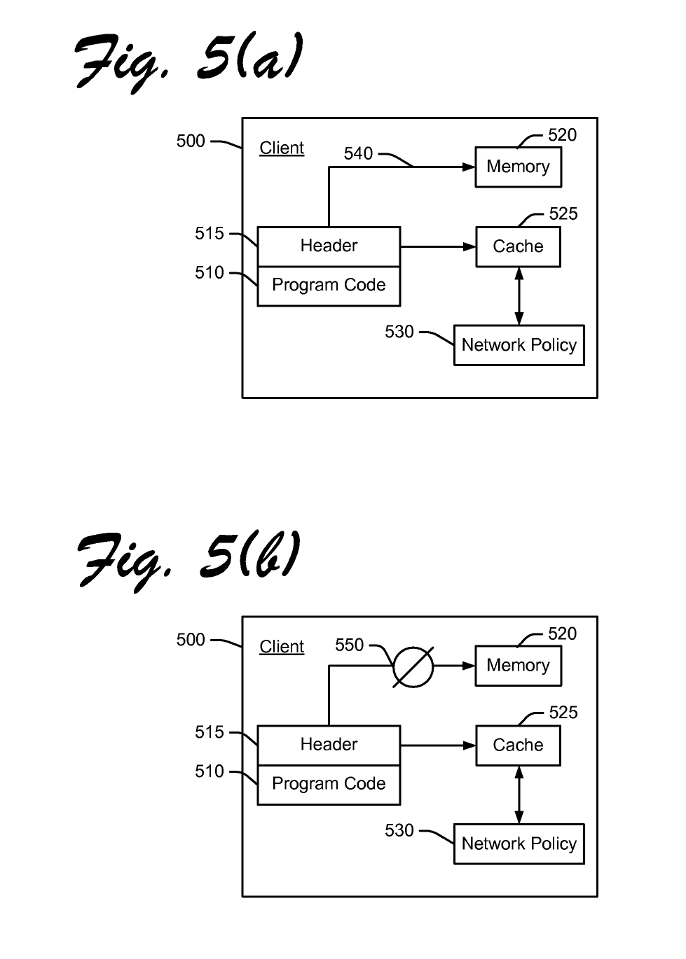

One or more network policies may be used to enforce one or more program code versions on a network. FIGS. 5(a) and (b) are schematic illustrations of a client showing an exemplary implementation of program code version enforcement. Referring to FIGS. 5(a) and (b), an exemplary client 500 may include program code 510 and memory 520. For purposes of illustration, it is assumed that the client 500 has already been authenticated in a domain on a network, although implementations are not limited to use only in domains.

During the logon process, client 500 is provided with at least a portion of an operating policy 530. Alternatively, the operating policy 530 may be provided to the client 500 in a implementation on computer-readable storage media. In one example, the operating policy 530 may be provided to the client 500 when the user installs word processing software from a CD. The operating policy 530 may define patch versions of Internet browser software.

Regardless of the mode for providing the operating policy 530 to the client 500, the operating policy 530 defines at least one version of compliant program code. In one implementation, the compliant version corresponds to the most recent patch and/or service pack which is available for the program code. The compliant version may be defined, for example, in an ACE discussed in more detail above.

When the client 500 attempts to access program code 510 (e.g., to execute database software) while connected on the network, a portion of the program code, such as header 515, is read to determine the version of program code 510 on the client 500. Although not required, this information may be written to a cache 525 so that the program code 510 can continue to be loaded into memory 520 for access thereto (e.g., execution of the database software).

The client version is compared to the version of program code satisfying the operating policy 530. If the client version satisfies the operating policy 530, the client 500 is granted access to the program code 510 (e.g., the database software is executed), as illustrated at 540 in FIG. 5(a). Alternatively, if the client version does not satisfy the operating policy 530, the client 500 is denied access to the program code (e.g., the database software is not executed and the user receives an error message), as illustrated at 550 in FIG. 5(b).

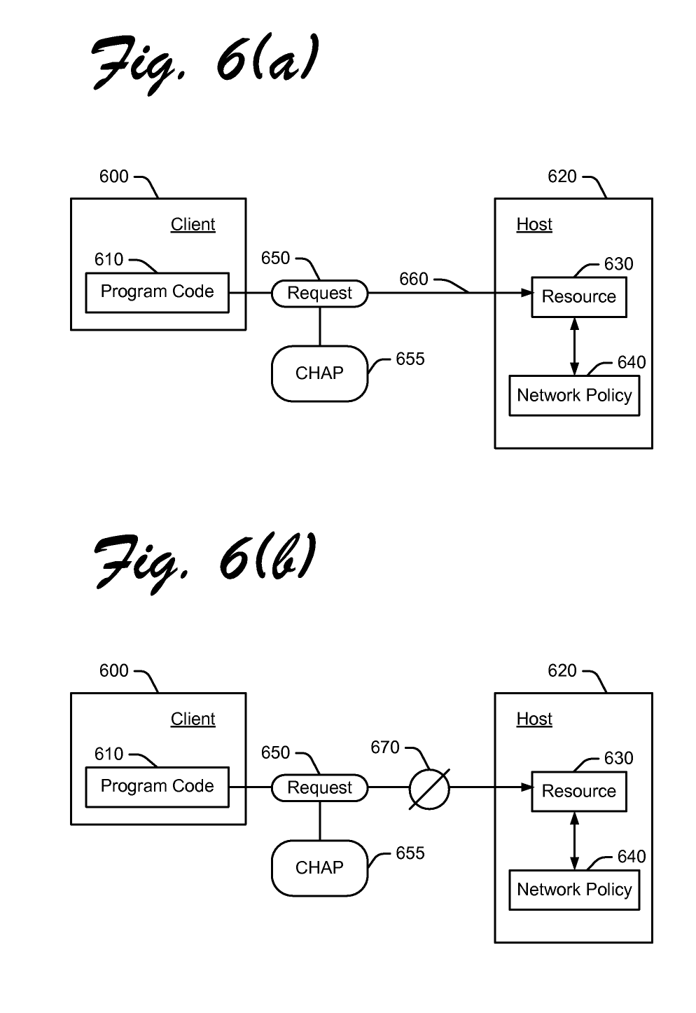

FIGS. 6(a) and (b) are schematic illustrations of a client and a host showing another exemplary implementation of program code version enforcement. As an example, program code version enforcement may be implemented according to this implementation for a client connected on the network but not authenticated in a domain. Such a client is said to be operating in a rouge domain. This may occur, for example, when a contractor connects to a business's network for Internet access but does not have rights to access other resources on the network.

Referring to FIGS. 6(a) and (b), exemplary client 600 includes program code 610 (e.g., database software). Exemplary host 620 includes at least one resource 630 (e.g., a database file) either provided at the host 620 or otherwise accessible via the host 620. Exemplary host 620 also includes an operating policy 640 to manage access to the resource 630.

When the client 600 attempts to access an resource 630 at the host 620, the client 600 makes a request 650 to host 620. The request 650 may contain the user's security credentials. For example, the user's credentials may be provided in a challenge-response packet (CHAP) 655 as part of the challenge-response protocol used by WINDOWS NT®-based operating environments (Microsoft Corporation). The CHAP 655 contains various security information and user privileges in the domain. CHAP 655 may also include the client version of program code 610 (e.g., the program code making the request 650).

When the host 620 receives request 650, host 620 compares the client version (e.g., in CHAP 655) with the version satisfying the operating policy 640. If the program code version is compliant with the operating policy, client 600 is granted access to the resource 630, as illustrated at 660 in FIG. 6(a). Alternatively, if the program code version is noncompliant, client 600 is denied access to the resource 630, as illustrated at 670 in FIG. 6(b).

If the client version is noncompliant, host 620 may also stop execution of the program code 610 at the client 600. Such an implementation may be implemented where, for example, execution of noncompliant program code is an actual or potential security risk for other devices on the network.

Further implementations of program code version enforcement are also contemplated. According to such another exemplary implementation, a host may deliver an error message to a client when program code at the client is not compliant with the operating policy. The error message may also include a link where a patch or service pack can be retrieved. In addition, a system administrator may be notified (e.g., by email) that the client has at least one noncompliant version of program code. The event may also be recorded in an event log.

In another implementation, the host may provide the patch(es) or service pack(s) to the client for installation. This process may be automated so that the patch or service pack is applied for the user. The user may be notified prior to installation of the patch or service pack on the user's device, and may even be prompted to accept installation of the patch or service pack. Alternatively, the user may be unaware of any changes to the user's system. The user may be notified during, or after the changes take effect (e.g., the patch installation), or the user may not be notified at all.

Of course one or more of these approaches may be implemented based on various design considerations. For example, the user may be notified prior to installation of the patch or service pack when the client is a device owned by the user (e.g., a contractor or an employee's home PC). On the other hand, the user may not be notified prior to installation of the patch or service pack when the client is a device owned by the network administrator (e.g., a workstation provided for employees by a business or for students at a university).

Exemplary Operations

Described herein are exemplary methods for implementing program code enforcement in a network environment. The methods described herein may be embodied as logic instructions on one or more computer-readable medium. When executed on a processor, the logic instructions cause a general purpose computing device to be programmed as a special-purpose machine that implements the described methods. In the following exemplary operations, the components and connections depicted in the figures may be used to implement program code version enforcement in a network environment.

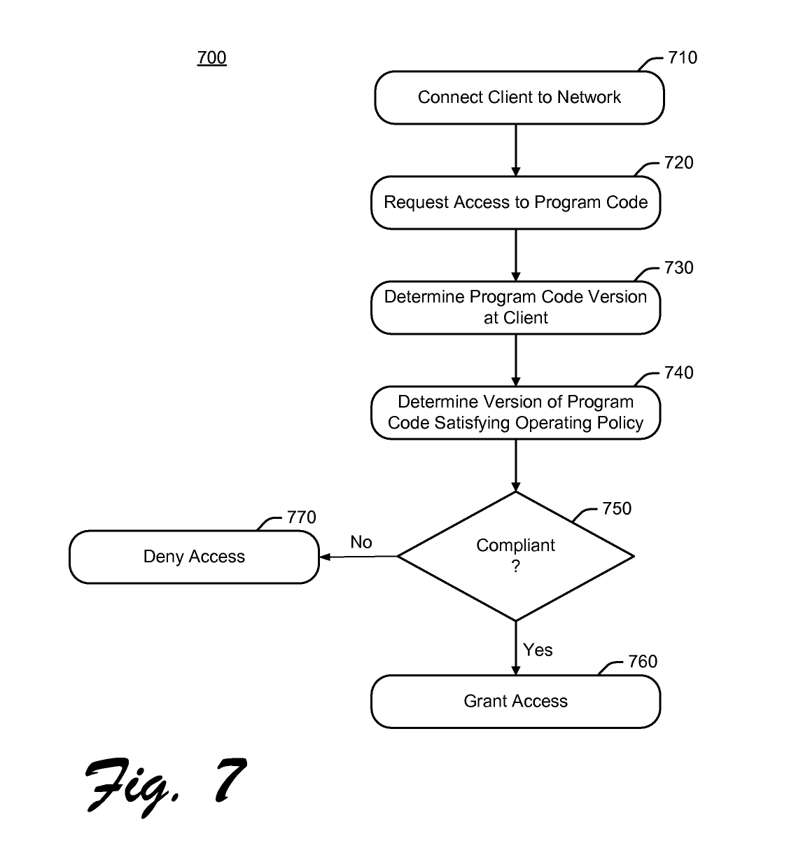

FIG. 7 is a flowchart illustrating exemplary operations 700 implemented by a client and/or host to enforce program code versions in a network. In operation 710, the client connects to the network, such as, e.g., via an Ethernet connection to a LAN or WAN. Optionally, the client is authenticated on the network during a logon session, although authentication is not required. During the logon session, the client may provide credentials for accessing the network. Operation 710 may also include authenticating the client on a domain in the network.

In operation 720, the client may make a request to access program code either at the client or elsewhere on the network. In operation 730, a version of the program code at the client is determined. For purposes of illustration, when a user requests to execute database software, the client may load one or more of the database executable and/or library files into memory. The executable and/or library files (or associated header) may include the program code version. Alternatively, the client may pass the program code version to the host, e.g., in a CHAP.

In operation 740, an operating policy is accessed to determine the compliant version of program code. For purposes of illustration, the operating policy may deny access to versions of database software that are prior to version 1.2.3.4.5.

In operation 750, a determination is made whether the requested program code version satisfies the operating policy. Continuing with our example, above, if the program code version is at least 1.2.3.4.5, it is compliant and access is granted in operation 760 (e.g., the database software executes). If the program code version is instead, e.g., 1.2.3.4.4, it is not compliant and the system denies access in operation 770.

When the program code version is not compliant, the system may respond according to any of a variety of different implementations. In exemplary implementations, the system may respond by issuing an error message, by denying the request to execute the program code at the client, by recording the event in an event log, by notifying the network administrator, by updating the program code version (e.g., by applying a patch or service pack or requesting the user to do so), or by any combination of these or other responses.

In addition to the specific implementations explicitly set forth herein, other aspects and implementations will be apparent to those skilled in the art from consideration of the specification disclosed herein. It is intended that the specification and illustrated implementations be considered as examples only, with a true scope and spirit of the following claims.

What is claimed is:

1. A method comprising:
determining a version of program code satisfying an operating policy; and
denying a client access to a resource if a version of the program code on the client attempting to access the resource is different from the version of program code satisfying the operating policy.

2. The method of claim 1, further comprising granting the client access to the resource when the version of program code on the client corresponds to the version of program code satisfying the operating policy.

3. The method of claim 1, further comprising determining the version of program code on the client in response to requesting access to the resource on a network.

4. The method of claim 1, further comprising determining the version of program code on the client during launch of the program code.

5. The method of claim 1, further comprising writing the version of program code on the client to a cache and then reading the cache while the program code is loading.

6. The method of claim 1, further comprising updating the program code on the client when the version of the program code on the client is different from the version of program code satisfying the operating policy.

7. The method of claim 1, further comprising notifying a user at the client if the version of program code on the client is different from the version of program code satisfying the operating policy.

8. The method of claim 1, further comprising notifying a network administrator if the version of program code on the client is different from the version of program code satisfying the operating policy.

9. The method of claim 1, further comprising recording in a log if the version of program code on the client is different from the version of program code satisfying the operating policy.

10. A system comprising:
an operating policy; and
a compliance module accessing the operating policy and denying a client access to a resource if a version of program code on the client attempting to access the resource is different from a version of program code satisfying the operating policy.

11. The system of claim 10, wherein the resource is available via a host on a network.

12. The system of claim 10, further comprising a notification module, said notification module notifying at least one of a user, an administrator, and a log when the version of program code on the client is different from a version of program code satisfying the operating policy.

13. The system of claim 10, wherein the operating policy includes at least one access control list (ACL).

14. The system of claim 10, wherein the operating policy includes at least one access control entry (ACE).

15. A computer program product encoding a computer program for executing on a computer system a computer process, the computer process comprising:
determining a version of program code satisfying an operating policy; and
denying a client access to a resource if a version of the program code on the client attempting to access the resource is different from the version of program code satisfying the operating policy.

16. The computer program product of claim 15 wherein the computer process further comprises determining the version of program code on the client in response to requesting access to the resource on a network.

17. The computer program product of claim 15 wherein the computer process further comprises determining the version of program code on the client while the program code is loading.

18. The computer program product of claim 15 wherein the computer process further comprises updating the program code on the client when the version of the program code on the client is different from the version of program code satisfying the operating policy.
